(19) United States
(12) Patent Application Publication
(10) Pub. No.: US 2008/0268781 A1
(43) Pub. Date: Oct. 30, 2008

(54) BLUETOOTH FM TRANSMITTER WITH PORT DETECT

(76) Inventor: Wong Man Chan, North Point (HK)

Correspondence Address: JOHN CHEN, ROOM 303, 3F, NO. 25, SEC. 1, CHANGAN E. ROAD, TAIPEI, 10441, TW

(21) Appl. No.: 11/953,841

(22) Filed: Dec. 10, 2007

(30) Foreign Application Priority Data
Apr. 29, 2007 (CN) 200720146303.X

(51) Int. Cl. H04B 7/00

(52) U.S. Cl. 455/41.3

(57) ABSTRACT

A bluetooth FM transmitter with port detect is the device comprising: a bluetooth communication unit, an audio input port, a connection circuit for corresponding port side, an FM radio emitter, an audio detecting circuit, a CPU, an echo canceller, an LCD, and a keyboard. Wherein the input port of the blue tooth communication unit and sound input port are through the connection circuit respectively connected to the FM radio emitter, the audio detecting circuit, the echo canceller, and the CPU. Wherein the echo canceller is connected between the connection circuit and the FM radio emitter, and the CPU connected to the audio detecting circuit, the LCD, the keyboard, the echo canceller, and the FM radio emitter.

### BACKGROUND OF THE PRESENT INVENTION

The present invention relates to the sound frequency transmitting technology, and it is major mentioned on the bluetooth device connected to frequency-modulated transmitter with port detecting (Audio DET) on the transmitting section.

### DESCRIPTION OF RELATED ARTS

The traditional FM radio is applied on radio broadcast about the frequency-modulated waveband, not related to the other wave signal receiving. The function is merely used way and applied range is narrow on the traditional FM radio, not related to the other wave signal detected from the Cellular phone or sound signal. So the applied requirement for traditional FM radio to receive the other wave signal is on the practical user's request.

### SUMMARY OF THE PRESENT INVENTION

The object of the present invention is to provide an automatic detecting device on the bluetooth communication port connected to the FM electrical appliance. The applied way is to install the sound receiving port and the bluetooth communication port on the FM electrical appliance. The FM radio signal from FM electrical appliance can be radiated applied by the present invention to radiate the specified signal originally from a sound receiving port and the blue tooth communication port.

To apply the present invention is to use an embodiment comprising: a bluetooth communication unit (or further comprising an audio input port), a connection circuit for corresponding port side, an FM radio emitter, an audio frequency detecting circuit, a CPU, an echo canceller, an LCD, and a keyboard. Wherein the input port of the bluetooth communication unit or the audio input port is through the connection circuit respectively to connect to the FM radio emitter, the audio frequency detecting circuit, the echo canceller, and the CPU. Wherein the echo canceller is connected between the connection circuit and the FM radio emitter, and the CPU connected to the audio frequency detecting circuit, the LCD, the keyboard, the echo canceller, and the FM radio emitter.

The above embodiment can further have a microphone connected to the echo canceller.

To apply the present invention is also to use another embodiment comprising: an audio input port (or further comprising a blue tooth communication unit), a connection circuit for corresponding port side, an FM radio emitter, an audio frequency detecting circuit, a CPU, an echo canceller, an LCD, and a keyboard. Wherein the audio input port or input port of the blue tooth communication unit is through the connection circuit respectively to connect to the FM radio emitter, the audio frequency detecting circuit, the echo canceller, and the CPU. Wherein the echo canceller is connected between the connection circuit and the FM radio emitter, and the CPU connected to the audio frequency detecting circuit, the LCD, the keyboard, the echo canceller, and the FM radio emitter.

The above embodiment can further have a microphone connected to the echo canceller.

The above embodiment can both have the audio input port and input port of the blue tooth communication unit.

The present invention has a practical enhancement effect, and it is can be applied on the field of the signal transmitting from the mobile phone and the microphone. It is applicable on the related field as simple structure, multi-function, convenient, and suitable on the fun of oral applied.

### BRIEF DESCRIPTION OF THE DRAWINGS

FIG. 1 is the circuit for the present invention

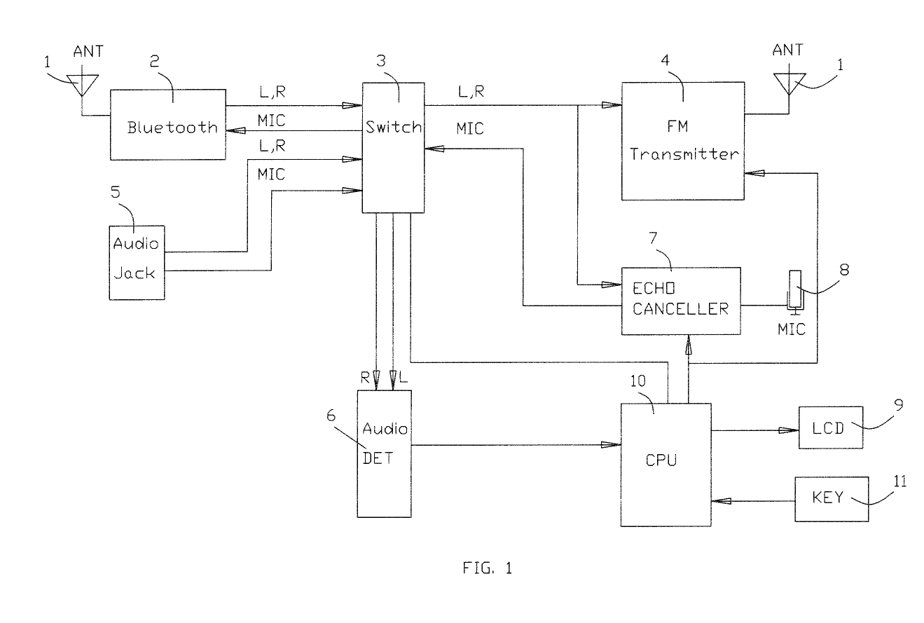

The reference numeral in FIG. 1 are: antenna 1, bluetooth communication unit 2 (Bluetooth), connection circuit 3 (switch), FM radio emitter 4 (FM Transmitter), audio input port 5 (Audio Jack), audio frequency detecting circuit 6 (Audio DET), echo canceller 7 (ECHO CANCELLER), microphone 8 (MIC), LCD 9, CPU 10, keyboard 11 (KEY)

### DETAILED DESCRIPTION OF THE PREFERRED EMBODIMENTS

The below description is combined the FIG. 1 to illustrate the present invention:

The FIG. 1 shows the present invention of bluetooth communication unit 2 (Bluetooth), connection circuit 3 (switch), FM radio emitter 4 (FM Transmitter), audio input port 5 (Audio Jack), audio frequency detecting circuit 6 (Audio DET), CPU 10, echo canceller 7 (ECHO CANCELLER), microphone 8 (MTC), LCD 9, keyboard 11 (KEY) and connected with other not shown parts (power supply, net connection box). Wherein the input port of the blue tooth communication unit 2 and audio input port 5 are through the connection circuit 3 respectively connected to the FM radio emitter 4, the audio frequency detecting circuit 6, the echo canceller 7, and the CPU 10. Wherein the echo canceller 7 is connected between the connection circuit 3 and the FM radio emitter 4, and the CPU 10 connected to the audio frequency detecting circuit 6, the LCD 9, the keyboard 11, the echo canceller 7, and the FM radio emitter 4. The power supply have the power sourcing the circuit in the FIG. 1.

Function of the invention includes:

1. bluetooth communication for wireless communication as input/output source; 2. the port on the mobile phone side to detect signal; 3. small power on FM emitting.

The above function can apply the mobile phone to generate the sound or the music to reach to a general frequency in the public application on FM radio. It is particular on the applied area of talking without hand-held device or music on broadcasting application in a vehicle.

Function description for the box principle and the reason in the FIG. 1 includes:

(1). Bluetooth: the communication device to a device also having the bluetooth communication device, and for the sound or data communication to a applied equipment such as a mobile phone.

(2). Switch: the connection switch as a channel from a side to the left, right, or microphone channel switching action, and can be control by the CPU.

(3). FM Transmitter: the conversion of the outside sound on the left or the right inside of the car space to change to the wave period on the FM's range, and the conversed data can be received by the outside radio.

(4). Audio Jack: for the ear phone of a mobile phone to plug in the Audio Jack port for sound communication.

(5). Audio Det: detecting the signal and sound channel from the left, right or the microphone, and with a device to inform the CPU to control the switch.

(6). Echo Canceller: for the echo excluded in the car, or in the air route of the vehicle, and in the space of a vehicle.

(7). MIC: the microphone as an un-handled type.

(8). CPU: the major processor.

(9). LCD: the LCD display, for display on the FM frequency, working mode (the displayed mark showing on dual audio channel effect, single sound-channel effect, the memorized frequency, the battery capacity left amount, the mode of MOBILE mode, the bluetoooth online mode.

(10). KEY: the function button.

The below is the operation reason description:

The presented circuit in the FIG. 1 can receive the signal (the sound or the data signal) from a mobile phone (with bluetooth function) by the bluetoooth communication unit 2, and transfer the received signal from the left or right side channel of sound through a connection circuit 3 to audio frequency detecting circuit 6. The audio frequency detecting circuit 6, Check which is R channel and which is L channel. Then inform CPU to control SWITCH to connect proper channel. The FM radio will receive the FM signal (Echo cancelled signal) and play the sound (or in music form). Wherein the CPU should send the order to the connection circuit 3.

In addition, the above circuit can also have connection way through the audio input port 5 to receive a various kinds of sound signal.

The applied way by the above presented circuit are:

a. In the vehicle wirelessly by free handed mode: at the period of outdoor calling in the bluetooth mobile phone for conversation, the signal will be transferred through the FM Transmitter (FM emitter 4) to the radio in the vehicle. The driver of the vehicle can also apply the microphone 1 to transfer the answer response to the corresponding user of outdoor calling in.

b. In the vehicle wired-connected by free handed mode: at the period of outdoor calling in the bluetooth mobile phone for conversation. The driver of the vehicle can also apply the wired-connected ear phone to transfer the answer response to the corresponding user of outdoor calling in.

c. Entertainment: In the vehicle, the bluetooth mobile phone can play the music through the present invention as device to connect the broadcasting equipment of the vehicle.

### Embodiment 1

### In the Vehicle

Stereo dual audio channel in the music processing: the portable media play device, including PDA (maybe with business function), MP3, CD player, can be applied by the present invention to transfer the signal of sound source to FM broadcast signal. Otherwise a mobile phone with type of Smart Phone (a kind of mobile phone maybe with the MS software in operation). The application of the present invention can apply various kinds of Smart Phone FM Transmitter to emit the signal to a vehicle's sound broadcast unit or a sound unit with an FM radio reception function. Through the Smart Phone FM Transmitter uses the latest Stereo technology, the sound effect of the present invention causes the same quality of MP3, MD, the laser disk drive player and the television. The present invention can use the PPL phase lock technique to guarantee the stable emitting on FM signal. The maximum transmission range may amount to 30 meters. The user can count on the Hi-Fi music as a reference music level in vehicle. (distortion rate: 0.3%)

The technology combination of Bluetooth: Smart Phone FM Transmitter can apply the application of the present invention with combination of Bluetooth and FM transmitter for exclude the constrained of wire connection. The present invention not only provides the wireless convenience, also to provide the Bluetooth conformity with the Stereo dual audio channel. The above application of Bluetooth technology conformity with mobile phone (includes the Smart Phone), PDA, the present invention for user can use the music playing to apply a kind of Smart Phone FM transmitter and from the FM transmitter with a Bluetooth device to receive the FM signal to act broadcasting of the sound signal in the music equipment of the vehicle.

In the vehicle wirelessly by free handed mode: The present invention applied on the Smart Phone FM Transmitter is not only constrained to play music from the vehicle on broadcasting. Moreover it has the function to apply the Bluetooth device on a mobile phone connecting to the Smart Phone FM Transmitter for communication on the mobile phone. In application of Smart Phone FM Transmitter, it constructs the high audio quality with anti-noise microphone. The Smart Phone FM Transmitter is allowable on transforming to vehicle wirelessly by free handed mode, the corresponding opposite user can use the music/sound equipment (the sound box) of the vehicle to broadcast, but the near user's sound penetrates Smart Phone FM Transmitter by the microphone for answering transmitting.

Convenience on sound recording: the convenience on application of Smart Phone FM Transmitter. In order to reach the convenience of vehicle driver and for the function to fast record the temporary important matter, the invention specially design sound recording record function, so long as presses down Smart Phone FM Transmitter the record key, the above device may carry on the sound recording immediately.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art.

1. A bluetooth FM transmitter with port detect, comprising:
A circuit having a blue tooth communication unit, a connection circuit for corresponding port side, an FM radio emitter, an audio detecting circuit, a CPU, all echo canceller, an LCD, and a keyboard;
Wherein the input port of the blue tooth communication unit is through the connection circuit to respectively connect to the FM radio emitter, the audio detecting circuit, the echo canceller, and the CPU;
Wherein the echo canceller is connected between the connection circuit and the FM radio emitter, and the CPU connected to the audio detecting circuit, the LCD, the keyboard, the echo canceller, and the FM radio emitter.

2. The bluetooth FM transmitter with port detect as described in claim 1, further comprising a microphone connected to the echo canceller.

3. An audio FM transmitter with port detect, comprising:
A circuit having an audio input port, a connection circuit for corresponding port side, an FM radio emitter, an audio detecting circuit, a CPU, an echo canceller, an LCD, a keyboard; and
Wherein the audio input port is through the connection circuit to respectively connect to the FM radio emitter, the audio detecting circuit, the echo canceller, and the CPU;
Wherein the echo canceller is connected between the connection circuit and the FM radio emitter, and the CPU connected to the audio detecting circuit, the LCD, the keyboard, the echo canceller, and the FM radio emitter.

4. An audio FM transmitter with port detect as described in claim 1, further comprising a microphone connected to the echo canceller.

5. An audio FM transmitter with port detect as described in claim 1, wherein the sound input port and the input port of the blue tooth communication unit is connected to the connection circuit respectively.

6. An audio FM transmitter with port detect as described in claim 3, wherein the sound input port and the input port of the blue tooth communication unit is connected to the connection circuit respectively.
